(19) United States
(12) Patent Application Publication
(10) Pub. No.: US 2008/0281871 A1
(43) Pub. Date: Nov. 13, 2008

(54) Method for Handling Electronic Documents

(75) Inventor: Lim Wong, Lidingo (SE)

Correspondence Address: NIXON & VANDERHYE, PC, 901 NORTH GLEBE ROAD, 11TH FLOOR, ARLINGTON, VA, 22203, US

(73) Assignee: KOCTEQ AB, Lidingo (SE)

(21) Appl. No.: 11/664,134

(22) PCT Filed: Oct. 14, 2004
(86) PCT No.: PCT/SE04/01472

§ 371 Date: Mar. 29, 2007

(51) Int. Cl. G06F 17/30

(52) U.S. Cl. 707/200; 707/E17.008

(57) ABSTRACT

The present invention relates to a method, a system, a computer readable medium and a computer program product that, by using extracting, generating and transforming, processes data directly for e-business (automated electronic business) services. Virtual printer functions extract difference data from difference sending information systems into unique XML (Extensible Mark-up Language) format. Editor functions are use to map information and produce a mapped file. Translator functions are use to translate information and produce a translated file. Engine functions generates the extracted data with the mapped and translated files into generated data. Routing and logging functions transform the generated data with security, routing and logging measure to the receiving designated system.

### TECHNICAL AREA

The present invention relates generally to communication of data between parties of communication networks and in particular to methods, a system and a computer readable medium for handling and communicating electronic documents in a network environment including a plurality of business and office systems comprising a large number of document formats.

### BACKGROUND OF THE INVENTION

World business communities are continuously searching for a standardized way of transferring information and communicate directly, efficiently and effectively. Without a means to transfer and communicate information directly from application to application, information preparation for these paper-based systems was labour intensive and slow. Furthermore, the manual processes of data entry and editing at both the sending and receiving ends of a business transaction could be very time consuming and error prone. Communication took place through the mail. The entire process added costs and time to operate properly.

The global competition is increasing and customers are demanding higher quality in the information they receive. In addition, the importance of quick and accurate information exchange, both within and between business entities, is growing. The Internet opens up the electronic market so that companies of all sizes can take advantage of what electronic trading has to offer. Market analysts predict that competitive pressure will push businesses to increase their use of the Internet. Moreover, pressure to improve customer loyalty will result in pressure to optimize the business processes. Its widespread availability, accessibility, and bandwidth offer new opportunities. The Internet facilitates real-time actions, which improves turnaround time. The accessibility of the Internet greatly widens the scope of a business beyond its physical storefront.

This makes it possible to trade with others around the world and around the clock using different computer systems and even different spoken languages. The new bandwidth capabilities enable us to send more data faster and cheaper thus minimizing the concern over the number of characters actually sent. These Internet components of availability, accessibility, and bandwidth can serve to lower the entry point costs and make B2B and B2C transactions available to more companies. The present invention makes it possible for partners to send electronic documents directly through the Internet regardless of their existing systems. It provides enough flexibility and scalability for real time interactive processes to transfer and communicate the right information to the right place at the right time.

In today's just-in-time business paradigm, the ability to enable direct, efficient and effective transferring and communicating information among a variety of applications from suppliers, vendors and partners is vital. The transformation to a fast business transaction cycle has several components. For example, the advantage of transforming to a faster cycle is that when a trading partner receives an order, transaction happens sooner and it is more likely that it will be correct and complete. This means the product will be shipped sooner and the receipt will arrive faster. In turn, this should lead to earlier payment authorization and payment receipt. If a company were to change the way things are currently done, they have to make major changes and this would disrupt crucial operations and systems. This could also affect business processes and the way transactions execute. These types of changes imply time, effort, programming costs, and possibly re-training of key trade process personnel.

Accordingly, there is a great need of systems for an automatic electronic document exchange but, however, there are a number of problems that has to be solved by such a system. One major problem is that there are a number of point-to-point issues that must be addressed with every business partner with whom a customer desires to transact business electronically. Point-to-point custom integration with trading partners require the coordination of technology, security standards and data formats between each pair of business partners. If companies want to engage with more than one business partner, the costs escalate exponentially since there may be a large number of document formats to be dealt with. Individual custom integration with each trading partner require several repetitive non-scalable solutions that have to be reworked each time there are changes to either end of the system.

Electronic Data Interchange (EDI) in one system for automatic electronic document exchange between trading partners that deals with point-to-point integration issues. However, companies are required to adhere to inflexible data formats and apparatuses and pay high proprietary network and interconnect costs. This results in a difficult, inflexible and expensive point-to-point integration with trading partners. Because EDI is expensive, it is typically used and managed by large corporations. Therefore, EDI solutions may be out of reach for smaller organizations and they do not scale easily to a large number of trading partners having a large number of business and office systems, and, accordingly, having a large number of document format.

In US 2003/0065623 a method and system for managing electronic document exchange between parties using a large number of document handling systems and document formats. According to this method and system, the transfer of a electronic document between a sending party having a first document format and a receiving party having a second document format is executed via a third party network, in which, for example, all transformation between different formats is performed. Accordingly, the exchange of all documents between all parties is routerred via the third party network, which may entail that the exchange during high load periods very slow. Moreover, the system and method inevitably becomes vulnerable for interruptions in the data traffic.

Thus, there is a need for a method and system for handling and communicating electronic documents between parties of a network including a plurality of business and office systems comprising a large number of different document formats that are within economical reach also for small an medium-sized companies and, in the same time, is reliable and efficient.

### SUMMARY OF THE INVENTION

An object of the present invention is to provide a method and system for handling and communicating electronic documents between parties of a network including a plurality of business and office systems comprising a large number of different document formats.

These and other objects are achieved according to the present invention by providing methods and chargers having the features defined in the independent claims. Preferred embodiments are defined in the dependent claims.

According to a first aspect of the present invention, there is provided a method for handling and communicating electronic documents between parties of a network including a plurality of business and/or office systems utilizing a large number of different document formats, comprising the steps of receiving an input electronic document, said input electronic document conforming to a format of a sender of said parties, intended to be transferred to a receiver of said parties; transforming said input electronic document into a intermediate format file; transforming said intermediate format file into an output electronic document using a predetermined mapping template, wherein said output electronic document conforms to a format of the receiver; and transferring said second electronic document to said receiver via said network.

According to a second aspect of the present invention, there is provided system for handling and communicating electronic documents between parties of network including a plurality of business and/or office systems utilizing a large number of different document formats, comprising: means for receiving an input electronic document, said input electronic document conforming to a format of a sender of said parties, intended to be transferred to a receiver of said parties; means for transforming said input electronic document into a intermediate format file; means for transforming said intermediate format file into an output electronic document using a predetermined mapping template, wherein said output electronic document conforms to a format of the receiver; and means for transferring said second electronic document to said receiver via said network.

According to third aspect of the present invention, a computer program for a system for handling and communicating electronic documents between parties of network including a plurality of business and/or office systems utilizing a large number of different document formats. The program comprises program instructions for performing the method according to the first aspect.

According to a fourth aspect of the present invention, there is provided a computer readable medium comprising instructions for bringing a computer to perform the method according to the first aspect.

The present invention is based in the insight of integrating end-to-end business information into an existing structure with minimum cost and effort. According to the present invention, all the client needs to do is to install and set-up a new printer function. Instead of a normal paper printout, a unique data file is extracted through a parser using a virtual printer function. After the data file is extracted it is transferred into an input format file. Then an editor is used to create the mapping template for this format and a translator is used to create the translating template for this format. Together with the mapping template and translating template, the input XML format file is transformed into a transformed data file with target format or standard, such as Global Invoice Specification (GIS), Financial Invoice (FINVOICE), etc.

This target format or standard file is easily transported via Internet for end-to-end solution by the routing and logging functions are finally used to structure the transformed data with security, routing and logging measure to the receiving designated system. This works especially well for companies with many clients having small and home office systems. It also makes it easy to decentralize information and reside to one main target location with the various clients and users dispersed at other locations. Using nothing more than a browser, the user can run and access the target format or standard file. With this we can solve companies complex problems, making it easier for smaller businesses to transfer and transport digital information. The transformation tool also provides a format that looks like ordinary documents using a viewer, such as an original Invoice or Purchase Order. The trading partner automatically completes the familiar looking format or standard and submits it for further processing. There is no need for in-depth knowledge and most of the transformation work takes place in the background behind the clients' system. This type of transformation suits very well for all applications and systems, both in large and small environments. In fact, it works well in any environment and it is now also possible for the larger trading partner to provide the same pre-defined format or standard according to their own requirements.

As realized by the person skilled in the art, the methods of the present invention, as well as preferred embodiments thereof, are suitable to realize as a computer program or a computer readable medium.

These and other advantages with, and aspects of, the present invention will become apparent from the following detailed description and from the accompanying drawings.

### SHORT DESCRIPTION OF THE DRAWINGS

In the following description of an embodiment of the invention, reference will be made to the accompanying drawings of which:

FIG. 1 shows schematically the installation process of the software product according to present invention;

FIG. 2 shows schematically a transaction between a supplier and a buyer using the method and system according to the invention;

FIG. 3 shows schematically a grouping object according to the present invention;

FIG. 4 shows schematically the mapping process according to the present invention;

FIG. 5 shows schematically a network in which the present invention can be implemented;

FIG. 6 shows schematically the system according to the present invention; and

FIG. 7 shows schematically an embodiment of the system according to the present invention.

### DETAILED DESCRIPTION OF THE INVENTION

In the following there will be discussed preferred embodiments of the methods and systems for handling and communicating electronic documents between parties of a network including a plurality of business and office systems comprising a large number of different document formats according to the present invention.

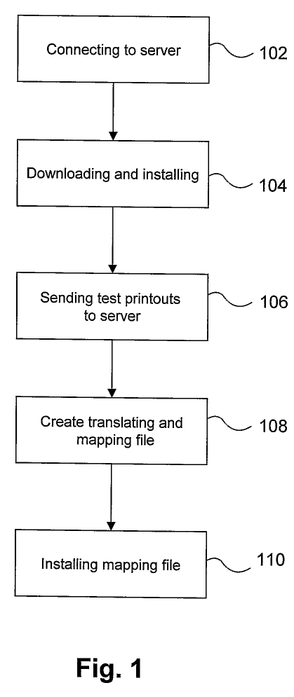

With reference first to FIG. 1, the installation process of the software product according to present invention will be described. First, at step 102, the sending party, e.g. a supplier, connects and enters the third party server connected to a network, for example, a web server connected to the Internet. The web server contains a virtual printing means, a engine means comprising managing means, a document router means, an editing means and document log means, which will be described in detail below. Then, at step 104, the virtual printing means, the engine means, the document router means is downloaded to the network of the sender and are installed on a computer or a server connected to the network of the sender. The virtual printing means produces a file in a predetermined data format, for example in XML format, which contains a geometrical description of an electronic document such as a electronic invoice. The geometrical description may comprises information such as where the address of the receiver is provided, where the amount of the invoice is provided, or where the goods specification is provided. In other words, each text fragment is described with its position and size. Other elements such as lines and images are also represented in a corresponding manner. Initially, the virtual printing means is configured to treat all printout, i.e. all files containing extracted data from electronic documents such as invoices, as test printouts. This means that the managing means does not perform any processing steps except sending the geometrical XML file over the Internet to the web server in order to produce a mapping template. The mapping template is a customer unique data file containing information regarding the geometrical positions of the electronic documents of the sender, for example, electronic invoices, in the format of the sender and the corresponding geometrical position data regarding the invoice format of the receiver. Accordingly, the test printouts should cover all possible cases of document looks, for example, a 1-page invoice or a 2-page invoice.

Accordingly, at step 106, the sending party produces and sends a test printout of all different electronic document by means of the virtual printing means. The purpose of the mapping process is to produce a customer unique (and document type unique) mapping file, given:
A number of test printouts received from the sender, i.e. supplier;
General knowledge (tax laws, etc.) about what information is required to appear on a document of the particular type (e.g. in an invoice); and
Knowledge of the specific receiver's information requirements.

The tool used in the translating and mapping process is the editing means. Depending on the situation, the mapping file:
is created from scratch;
is created from a template (from a well-know business system); and
is opened, modified, and stored.

That is, at step 108, the customer unique translating and mapping file is created. Then, at step 110, the mapping file or template is installed on the computer or server of the sender. The mapping file can be sent by means of an e-mail or via the Internet. Updates of the mapping file can be executed via the Internet. The mapping file is also stored on the web server. Whenever a modification of the layout of an electronic document of the sender is performed, a mapping file modification has to be performed, and thus a new test printout has to be sent in accordance with the above given description for each modified electronic document. The user can initialize this modification procedure by selecting a test icon provided in the interface displayed on the screen, thereby the next printout will be considered as a test printout and the file is transported to the web server. The user can also select an already sent document from a Log frame provided by the document log means and send that one as a test printout. The Log frame logs all sent document and will be described in detail hereinafter. According to an alternative embodiment of the present invention, all program instructions and files, e.g. the mapping files associated with the different receivers, described above stored at the sender, are stored at a separate server, which may include the program instructions and files for a large number of sending parties. In this case, the sender connects to the server each time a document, for example, an invoice is to be sent.

The position information or data discussed above is represented by means of so called boxes. These boxes play two main roles:
positioning (reference) boxes define the absolute positions on the page of certain reference data elements. For example, a positioning box can state the text “Invoice” is expected to be found at the absolute position of (x=500, y=25) from the top-left corner of the page for this particular source document. Such positions may vary from document to another, due to, for example, page-size settings. Preferably, the coordinates starts with (x=0, y=0) on the top-left corner of the page with increased values rightwards and downwards, respectively.
collecting boxes capture text fragments from source documents together with their layout. Text must be positioned inside the boundaries of the box (or in other words, the geometrical centre of each text fragment's bounding box needs to fall inside the boundaries of the collecting box). Collecting boxes must either be of type Abox (see below) or need to have proper number of anchors attached.

There are three main types of boxes:
Anchor box (Abox): anchor boxes can play either of the two roles. First, they can serve as anchor points on the page to define absolute positions of relative boxes and in this role they do not collect any content from the source documents. Second, when they are not connected to any other box they can collect the content themselves, i.e. they are equivalent to absolute-position collecting boxes. Aboxes are turned ON (for collecting) if: the current page number is on the list of valid pages or the regular expression matches text that falls within Abox boundaries (plus/minus some tolerance margins). Otherwise Abox is turned OFF for collecting on the current page. This means that all connected relative-position boxes will be turned off as well. Absolute position of Abox is determined individually for each page, based on its original position on the page, plus/minus some tolerance, defined as so called “shifts”. This means that if the content on the current source document page is somewhat shifted as compared with the reference document, but there is a text that would still match the regular expression defined for this Abox, the “shifts” are applied. These tolerance margins can be set individually for each Abox.
Relative-position box (Rbox): which is a collecting box, which always must be connected to exactly one anchor box. Absolute position of Rbox on a given page is determined by absolute position of its anchor box plus the distance from the anchor box. This means that if a specified pattern is detected on a given page by the Abox, this Abox might be shifted by tolerance margins into nay direction, and it will “pull” all connected Rboxes with it to a new, “shifted” position. In such case, Abox is turned On, and this is a signal to all connected Rboxes to start collecting the content that falls within their boundaries. To summarize,
   An Rbox must be connected to exactly one Abox.
   If an Abox is tuned ON for collecting on a given page, the absolute position of the Rbox is adjusted based on the “shifts” applied to the Abox and the distance between the Abox and the Rbox. If the current page number is on a list valid pages for this rbox, Rbox is turned ON for collecting and starts to capture the text that falls within its boundaries.
Variable-length relative box (Vbox): is a collecting box that always must be connected to exactly two anchors. The horizontal position of a Vbox on a page may be fixed. Vertical positions of the top and bottom ends of the Vbox are determined by absolute positions of anchor boxes attached to each end, and, accordingly, the may vary from page to page as the Aboxes are shifted. In addition to that, the Vbox offers a possibility to define an internal structure in tabular layout, i.e. it is possible to define that source data should be collected in a series of columns. Column widths can be defined either static (in pixels), or dynamic (in percent of Vbox width). A Vbox is triggered for collecting according to the following rules:
   Both anchor boxes must be attached on a given page.
   Both anchor boxes must be turned ON.
   Vbox top and bottom ends are adjusted based on the current absolute position of Aboxes and originally defined distances between them and Vbox. These adjustments may differ from page to page.

As indicated above, the document log means stores incoming and outgoing messages including data messages, for example an invoice, and signals including:
inactivity corresponding to a timeout, i.e. a message or signal has not been sent or received; and
a receipt: The receiver of a data message can return a receiver receipt showing whether the receiver has received the data message.

Each message and signal is uniquely identified by mean of an ID.

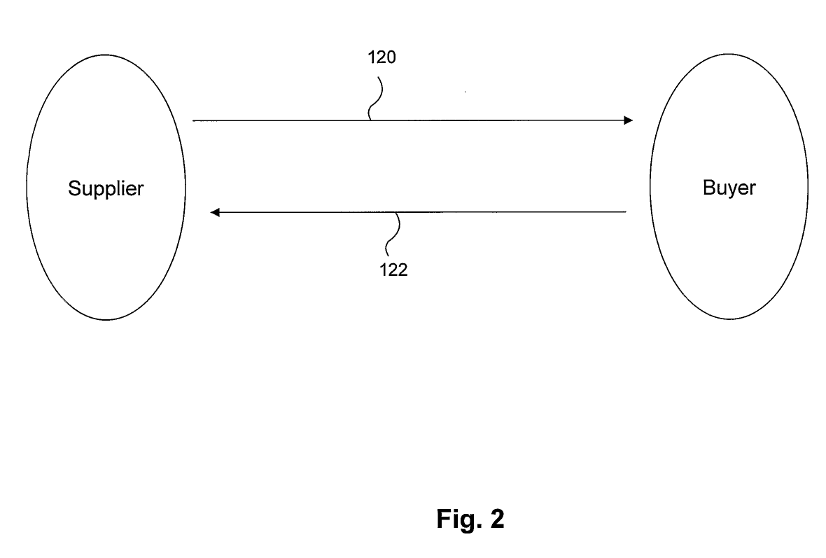

With reference now to FIG. 2, a transaction between a supplier and a buyer using the method and system according to the invention will be described. First, at step 120, an electronic document, for example an electronic invoice, is sent from the supplier's network using a business system different from the system of the buyer in a format of the buyer after being transformed from the supplier's format in accordance with the method of the invention, which will be described hereinafter. Then, at step 122, at receipt at the buyer, a receipt is sent to the supplier showing whether the supplier has received the message. According to an alternative embodiment of the present invention, all program instructions and files, e.g. the mapping files associated with the different receivers, described above stored at the sender, are stored at a separate server, which may be placed at a third party and the sender and the buyer is connected to the server via a communication network, for example the Internet. The server may include the program instructions and files for a large number of sending and receiving parties. In this case, the sender connects to the server each time a document, for example, an invoice is to be sent and all functions are performed at the server.

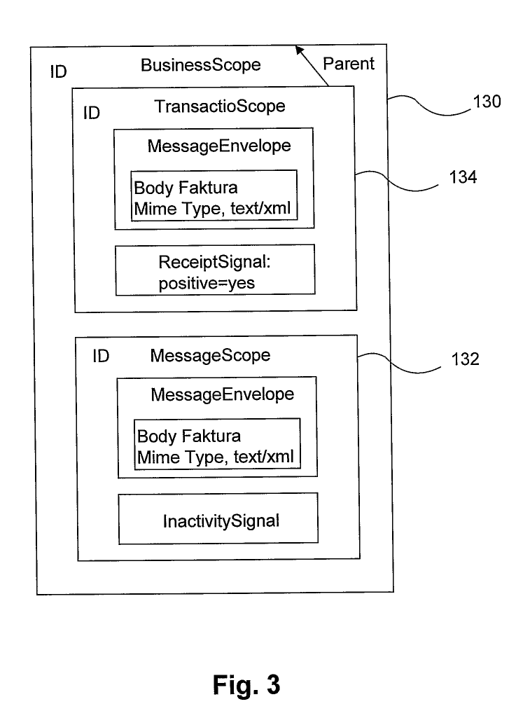

In order to be able to group different messages and signals a so called BusinessScope 130 acting as a grouping object is used, as shown in FIG. 3. Preferably, the BusinessScope 130 comprises a Message scope 132, which groups a message together with an arbitrary number of signals, and a TrancationScope 134, which groups an outgoing message with an incoming message and an arbitrary number of signals. There is only one BusinessScope per unique ID.

Hereinafter, the logging process according to the present invention will be described. First, a logging method of the document logging means is called. In this call, a LogUser object is associated with a message or signal, which object represents the code that calls the logging method. This LogUser object can be used by the logging means if it needs any information in the calling code, i.e. call-back functionality. The information is passed further on via delegating to class performing the storing in a database. Thereby, it is possible at a later stage to swap the storage to a class having another or higher quality (QoS) without changing the interface and the logging methods.

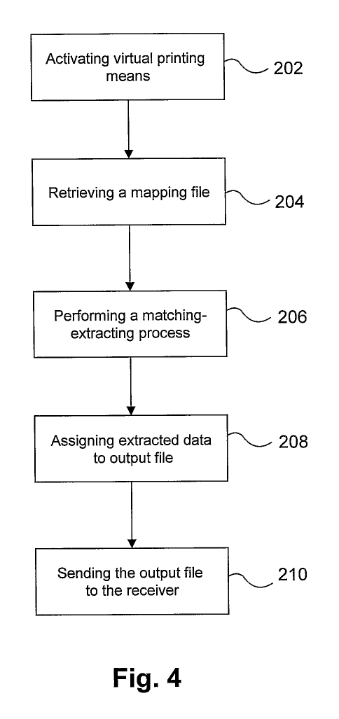

With reference now to FIG. 4, the mapping process will be described. In order to send an electronic document, such as an electronic invoice, to a receiver, where the receiver uses a business system utilizing a file format different from the business system and file format of the sending party, the sending party activates a virtual printing means installed on a computer or server of the network of the sending party, i.e. redirects the invoice to the printing means. This can be performed, for example, by activating an icon symbolizing the virtual printing means presented on a screen. If the program performing the method of the present invention is stored on a server, the sending party connected to the server in order to activate the virtual printing means. At activation, at step 202, the virtual printer produces a file in a predetermined data format, for example in XML format, which contains a geometrical description of the printout as discussed above, i.e. where the address of the receiver is provided, where the amount of the invoice is provided, or where the goods specification is provided. In other words, each text fragment is described with its position and size. Other elements such as lines and images are also represented in a corresponding manner. Then, at step 204, a managing means retrieves the file containing geometrical data from the virtual printing means, i.e. the mapping file. At step 206, the managing means performs a matching-extracting process on the file where the extracted information is checked, i.e. whether the information appear in the proper position on the proper page. In order to check the extracted information the mapping template or mapping file is used. This mapping file is predefined, as described above, and unique for each document type and may be stored on, for example, a computer or server of the network of the sender. If the extracted data is correct, the extracted data is assigned to the corresponding variables in an output file at step 208, which output file is a logical XML file. Finally, at step 210, the output file is transferred to the receiver via the network, which output file is in a format conforming to the business system of the receiver.

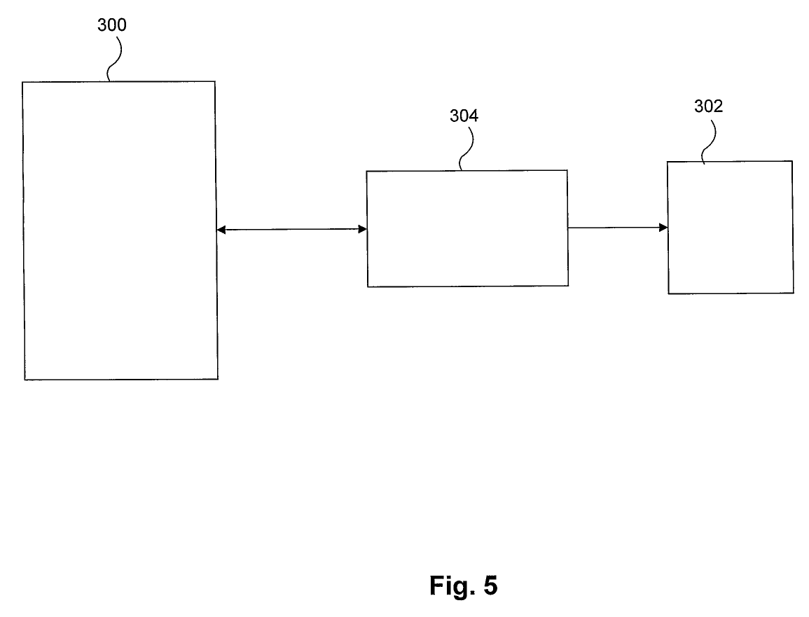

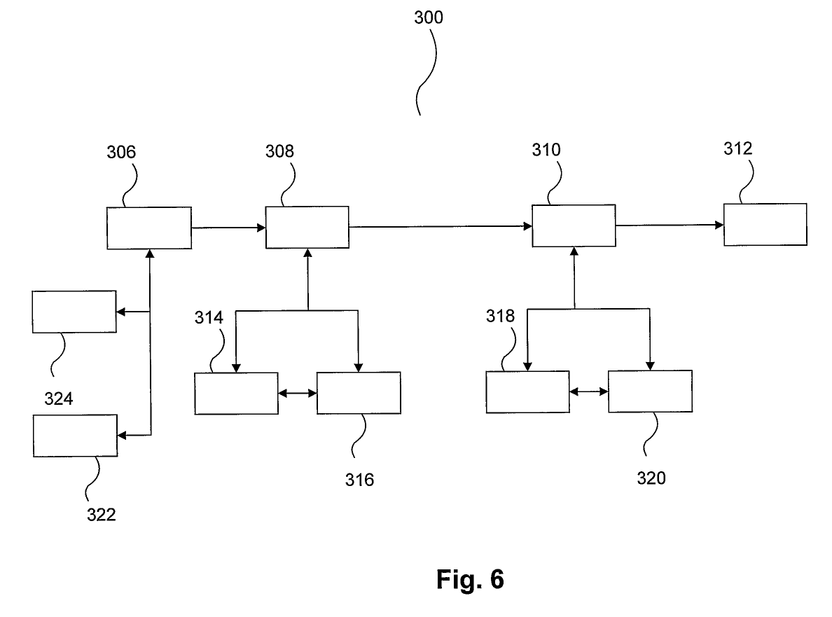

With reference now to FIGS. 5 and 6, a system according to the present invention will be described. A sending information system 300 and a receiving system 302 are connected to a network 304, such as the Internet. The sending information system 300 uses a business system and file format different from the business system and file format of the receiving system 302, see FIG. 5. Turning now to FIG. 6, a preferred embodiment of the present invention will be described. Means for receiving an input electronic document 306, for example, an electronic invoice, the input electronic document conforming to a format of the sending system, intended to be transferred to the receiving system 302; means for transforming the input electronic document into a intermediate format file 308; means for transforming said intermediate format file into an output electronic document using a predetermined mapping template 310, wherein the output electronic document conforms to the format of the receiving system 302; and means for, via the network 304, transferring said second electronic document to the receiving system 312 are arranged in the sending system 300. This sensing system may as discussed above be arranged at a computer system at the sending party or at a server at a third party.

Furthermore, means for extracting data from predetermined positions of the input electronic document 314; and means for storing the data in the intermediate format file 316 are arranged in the sending system 300.

In addition, means for retrieving the mapping template 318, which template comprising positions matching information regarding the electronic document format of the receiving system 302; and means for assigning said extracted data to positions in the output electronic document in the format of the receiving system 302 corresponding to the positions in said input electronic document by using said mapping template 320 are arranged in the sending system 300.

Moreover, means for predefining document specifications associated with the receiving system 322; and means for predefining documents specifications associated with the sending system 324 are arranged in the sending system 300. Preferably, the document specifications associated with the receiving system 302 comprises document format of the electronic documents to be received from the sending system 300 and the document specifications associated with the sending system 300 comprises document format of the electronic documents of office network system of the sender to be sent to the receiver.

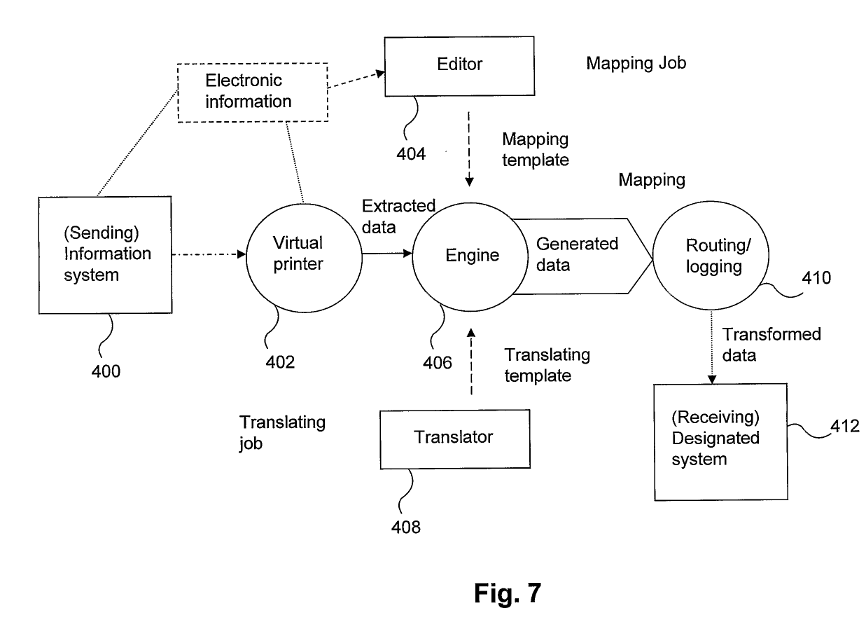

Referring now to FIG. 7, the data flow in a preferred embodiment of the electronic document handling system will be discussed. This invention provides a complete system, computer software and method of extracting, generating and transforming data directly for e-business (automated electronic business) services. The system comprises a virtual printer 402 connected to a sending system 400, an editor 404, a translator 406, an engine 408, a routing/logging function 410. Furthermore, the sending system is connected to a receiving system 412 via a network. The unique virtual printer 402 extracts difference data from different sending information systems 400 into a unique XML (Extensible Mark-up Language) format. The editor 404 functions are used to mapped information and produce a mapped file. The translator 406 functions are use to translated information and produced a translated file. The engine 408 then generates the extracted data with the mapped and translated files into generated data. The routing and logging function 410 finally transforms the generated data with security, routing and logging measure to the receiving designated system.

Hereinafter, the function of the virtual printing means will be described in more detail. Users may invoke the print function from any operative system, for example, a Windows application (most commonly a business system). Instead of using their default printer they use the virtual printing means, a so called “DQManager Printer Driver”. The printout is then converted on the fly from internal representation (as GDI calls) to the output XML format, and put into a specified storage location.

In an Unix environment, the users may invoke the print function through a Unix printing subsystem, such as Berkeley LPD or CUPS. The only format supported as an input to the DQManager Driver is PostScript, so any Unix application that wants to use it must be able to produce printouts in PostScript (unless some special third-party converters are used). The DQManager Driver then converts the PostScript printout into XML output.

Using a DOS platform, the uses have to use original printer drivers supplied with the applications. The printouts are redirected to a network printer port (using built-in DOS “net use” command), located either on the same machine (if the application executes in a DOS command-line window under Windows systems), or to another machine running Windows on the same local network. The printout must be made using drivers for one of the supported Epson printer models. This printout is then redirected using a printer port redirector module to a temporary file. Finally, this file (still in Epson print format) is converted by a Java application to the output XML format.

The following configuration parameters are supported on all platforms:
Output path: path where the output XML files will be stored. Only complete files are stored there, i.e. the initial output file is created somewhere else (in user's TEMP directory, or in /tmp), and then renamed atomically. We assume the output path is on the same volume as the temporary path.
The output files are uniquely named, using the following format: dqYYYY-MM-DD_hh-mm-ss-uuu.xml
Y—year (e.g. 2004)
M—month (e.g. 01)
D—day in month (e.g. 01)
h—hour (00-24)
m—minute (00-59)
s—second (00-59)
u—millisecond (000-999)
Paper size and paper orientation configuration. On some platforms (such as Windows) this information is available to applications, so that they may adjust the page layout. On other platforms (Unix and DOS) this is purely a preference, if no other information can be obtained from the input files.
A boolean option to turn on/off the output of graphical elements from the printouts. When this option is de-selected, the driver outputs ONLY the textual content, i.e. all sub-elements of “Page”, except “Box”, are absent. If this option is selected, all elements specified in DTD are provided as needed.

On Win32 platforms, the driver is implemented as a modified EMF printer driver. It is installed the same way as any other printer driver, and it interacts with the GDI subsystem in the same way.

The capabilities reported to GDI are those of the EMF format. This is the responsibility of the EMF mini-driver (because the whole driver uses UNIDRV infrastructure, plus a mini-driver implementation). There are two versions of the mini-driver—one for 16-bit architecture used by Windows 98, and the other for 32-bit architecture used by other Windows versions.

EMF is a robust vector-oriented graphical format, capable of rendering complex combinations of text, pixel graphics and vector paths. Therefore, only a minimal amount of work is needed in the driver to get an internal representation of the printout as EMF data. This also guarantees that the EMF data looks very close to the actual physical printout.

This EMF data can be optionally saved to files (one file per logical page of the printout). It is also converted in-memory to the XML representation according to the specification below. Some complex transformations are needed because of the limitations in the XML format:
pixel graphics data is converted to PNG format
complex paths are converted into polygons
gradient and pattern fills are approximated by solid fills
patterned lines are replaced by solid lines
on Windows 98 platform characters in the native code page are converted to Unicode encoding; on other platforms this process uses underlying facilities of the operating system.

The Windows drivers support also an additional configuration option, which determines whether the EMF data should be saved to files. For each printout there are one or more EMF files created, and they are put in the output directory, in a subdirectory named after the name of the XML output file.

On Unix platforms, the Postscript output from applications is sent to a printing subsystem, such as LPD or CUPS. For both of these subsystems the installation program can add appropriate entries to connect the driver to the rest of the subsystem.

The driver is implemented as a custom version of graphical device for GhostScript interpreter. This device uses the rest of Ghostscript infrastructure to properly interpret input Postscript file, and based on the graphical primitives present in the PS file it produces XML output directly. The system uses Bourne shell scripts to provide necessary environment variables and arguments, whether invoked directly from the command line, or as a so-called input filter, which is run as a part of the printing process by the printing subsystem.

The Ghostscript interpreter uses a collection of fonts, which may or may not correspond closely to the fonts used by the applications. If that is the case, the system administrator should install appropriate font metric files (Adobe Font Metrics, *.afm files), which describe the missing fonts. This is not strictly required in most cases, because Ghostscript can make quite appropriate font substitutions if some of the metric definitions are missing.

Existing scripts can also be modified to take advantage of the system-wide font collections in Postscript format. Please see Ghostscript manual for more information.

The information flow for the DOS platform is different from the other platforms, because of limitations of printing support. Every DOS application comes with its own printer drivers, so there is no single point of integration as it is with Unix and Windows. A small redirecting printer driver is needed in order to capture the DOS printout and invoke a Windows-based format conversion tool for the printouts.

According to a preferred embodiment of the present invention, the converter is a Java component to be integrated with the current Java part of the DQManager client. This component takes the ESC/P printout and produces an XML output according to the specification (see below). This output can be either saved to one of the ordinary processing queues in DQManager, or passed directly to the processing module inside DQM using an in-memory String representation.

Now, the specifications of the output XML file will be discussed.
Rectangular areas containing text. Font name, point size, weight and foreground color should be specified. Bounding box dimensions should be calculated, if not already provided. Rectangular areas containing pixel graphics (i.e. rectangular pictures, bitmaps, etc.). Since the output needs to be portable and XML-safe, such graphics is encoded into PNG format and then Base-64 encoded.
The pixel graphics can be supplied in a variety of color-space models, including those with support for Alpha (transparency) channel.
Color: the foreground color parameter is used where appropriate, expressed as RRGGBB values.
Fill: the driver supports only solid fills, i.e. it just indicates whether a shape is filled, and if so with what color. If this attribute is not present, it is assumed the shape is not filled.
Line color: the driver reports the contour (line) color for each shape. If this attribute is not present, it is assumed that the contour is invisible.
Polygons: the driver handles polygons, expressed as series of Point values, and with a line width parameter.
Arcs, including circles and ellipses. Arcs are specified by (x, y) and (w, h), which defines a bounding box (rectangle) fitting the full ellipse

Although specific embodiments have been shown and described herein for purposes of illustration and exemplification, it is understood by those of ordinary skill in the art that the specific embodiments shown and described may be substituted for a wide variety of alternative and/or equivalent implementations without departing from the scope of the invention. Those of ordinary skill in the art will readily appreciate that the present invention could be implemented in a wide variety of embodiments, including hardware and software implementations, or combinations thereof. As an example, all functions of the inventive method and the system can be implemented in a server connected to a large number of sending systems and receiving systems. This application is intended to cover any adaptations or variations of the preferred embodiments discussed herein. Consequently, the present invention is defined by the wording of the appended claims and equivalents thereof.

1. Method for handling and communicating electronic documents between parties of a network including a plurality of business and/or office systems utilizing a large number of different document formats, comprising the steps of
receiving an input electronic document, said input electronic document conforming to a format of a sender of said parties, intended to be transferred to a receiver of said parties;
transforming said input electronic document into a intermediate format file;
transforming said intermediate format file into an output electronic document using a predetermined mapping template, wherein said output electronic document conforms to a format of the receiver; and
transferring said second electronic document to said receiver via said network.

2. Method according to claim 1, wherein the step of transforming the input document further comprises the steps of:
extracting data from predetermined positions of said input electronic document; and
storing said data in said intermediate format file.

3. Method according to claim 1 or 2, wherein the step of transforming said intermediate format file comprises the steps of:
retrieving said mapping template, said template comprising positions matching information regarding the electronic document format of said receiver; and
assigning said extracted data to positions in said output electronic document in said format of the receiver corresponding to the positions in said input electronic document by using said mapping template.

4. Method according to claim 1-3, further comprising the steps of:
predefining document specifications associated with the receiver; and
predefining documents specifications associated with the sender.

5. Method according to claim 4, wherein said documents specifications associated with the receiver comprises
document format of the electronic documents to be received from the sender.

6. Method according to claim 4 or 5, wherein said documents specifications associated with the sender comprises
document format of the electronic documents of office network system of the sender to be sent to the receiver.

7. System for handling and communicating electronic documents between parties of network including a plurality of business and/or office systems utilizing a large number of different document formats, comprising:
means for receiving an input electronic document, said input electronic document conforming to a format of a sender of said parties, intended to be transferred to a receiver of said parties;
means for transforming said input electronic document into a intermediate format file;
means for transforming said intermediate format file into an output electronic document using a predetermined mapping template, wherein said output electronic document conforms to a format of the receiver; and
means for transferring said second electronic document to said receiver via said network.

8. System according to claim 7, further comprising
means for extracting data from predetermined positions of said input electronic document; and
means for storing said data in said intermediate format file.

9. System according to claim 7 or 8, further comprising:
means for retrieving said mapping template, said template comprising positions matching information regarding the electronic document format of said receiver; and
means for assigning said extracted data to positions in said output electronic document in said format of the receiver corresponding to the positions in said input electronic document by using said mapping template.

10. System according to claim 7-9, further comprising:
means for predefining document specifications associated with the receiver; and
means for predefining documents specifications associated with the sender.

11. System according to claim 10, wherein said documents specifications associated with the receiver comprises
document format of the electronic documents to be received from the sender.

12. System according to claim 10 or 11, wherein said documents specifications associated with the sender comprises
document format of the electronic documents of office network system of the sender to be sent to the receiver.

13. Computer program for a system for handling and communicating electronic documents between parties of network including a plurality of business and/or office systems utilizing a large number of different document formats, characterised in that said program comprises program instructions for performing the steps of any one of the claims 1-6.

14. Computer readable medium comprising instructions for bringing a computer to perform the method according to any one of the claims 1-6.
